(19) United States
(12) Patent Application Publication
(10) Pub. No.: US 2014/0330733 A1
(43) Pub. Date: Nov. 6, 2014

(54) SYSTEMS AND METHODS FOR GRAPHICAL DISPLAY OF GEOGRAPHIC DATE FOR EMPLOYMENT OPPORTUNITIES

(71) Applicant: Le Phuoc Thang Nguyen, Anaheim, CA (US)

(72) Inventor: Le Phuoc Thang Nguyen, Anaheim, CA (US)

(21) Appl. No.: 13/874,734

(22) Filed: May 1, 2013

(51) Int. Cl. G06Q 10/10

(52) U.S. Cl. CPC G06Q 10/1053
USPC 705/321

(57) ABSTRACT

The invention relates to systems and methods graphically displaying geographic data corresponding to multiple employment opportunities, such as by displaying points on a map. In an embodiment, the system includes an employment search server that is operatively coupled to a public network, and has a database that stores data associated with a plurality of employment opportunities, and data associated with a plurality of users. The system receives employment opportunities information entered by an administrator or a potential employer, finds geographic data for the employment opportunities using a map service, and stores the geographic data in the database. When the system receives a query from a user for one or more employment opportunities, it searches the database for employment opportunities corresponding to the query, then uses the geographic data of those employment opportunities to display those employment opportunities, such as by displaying points on a map. The system may also display the location of the user on the map.

### FIELD OF THE INVENTION

The field of the invention relates to systems and methods for displaying employment opportunities. More particularly it relates to systems and methods that enable the graphical display of geographic data for employment opportunities.

### BACKGROUND OF THE INVENTION

An increasing and significant number of potential employees looking for employment opportunities search online, e.g., using the Internet. In particular, when searching for employment, an online user usually enters a job title or description and a geographic location. The job search site then returns a listing of job opportunities. Some job search sites allow the user, such as a job seeker, headhunter or employment agency, to search a particular city where each job is located, or to specify a distance, e.g., in miles, of the desired job from a particular geographic location. However, unless the user knows well the geography of the area, and has an encyclopedic knowledge of street names and numbers, he or she will still not know where the job is located relative to the user's most desired location or relative to other opportunities. The user will have to search for, or manually look up the address of the hiring company, then separately enter that address into an online map application, e.g., Google Maps, Apple Maps, MapQuest, and so on, and repeat the same steps for each job in the listing. This is very inconvenient and very inefficient, making the job search process very slow and time consuming, especially when there are hundreds of jobs to review, and subject the results to the errors of the user when entering the addresses of the employment opportunities. Accordingly, improved systems and methods for enabling the display of accumulated job search results may be desirable.

### SUMMARY OF THE INVENTION

The invention includes systems and methods for graphically displaying geographic data, such as points on a graphical display of a map, corresponding to the locations of multiple employment opportunities. In an embodiment, the system includes an employment search server which is operatively coupled to a public network, and has a database that stores data associated with a plurality of employment opportunities, and data associated with a plurality of users. The system receives employment opportunities information entered by an administrator or an employer, finds geographic data for the employment opportunities using a map service, and stores the geographic data in the database. When the system receives a query from a user for one or more employment opportunities, it searches the database for one or more employment opportunities with at least one match with the employment opportunity query, then uses the geographic data of those employment opportunities and the map service to display those employment opportunities on a map. The system may also display the location of the user on the map.

Other systems, methods, features and advantages of the invention will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 is an exemplary diagram of a system for graphical display of geographic data according to an embodiment of the present invention.

FIG. 2 is an exemplary diagram of a server system for graphical display of geographic data according to an embodiment of the present invention.

FIGS. 3a-3b are an exemplary user interface according to an embodiment of the present invention.

FIG. 4 is another exemplary user interface according to an embodiment of the present invention.

FIG. 5 is another exemplary user interface according to an embodiment of the present invention.

FIG. 6 is another exemplary user interface according to an embodiment of the present invention.

FIG. 7 is another exemplary user interface according to an embodiment of the present invention.

FIG. 8 is an exemplary process of a system for graphical display of geographic data according to an embodiment of the present invention.

FIG. 9 is another exemplary process of a system for graphical display of geographic data according to an embodiment of the present invention.

### DETAILED DESCRIPTION OF THE PREFERRED EMBODIMENTS

### Preferred Systems

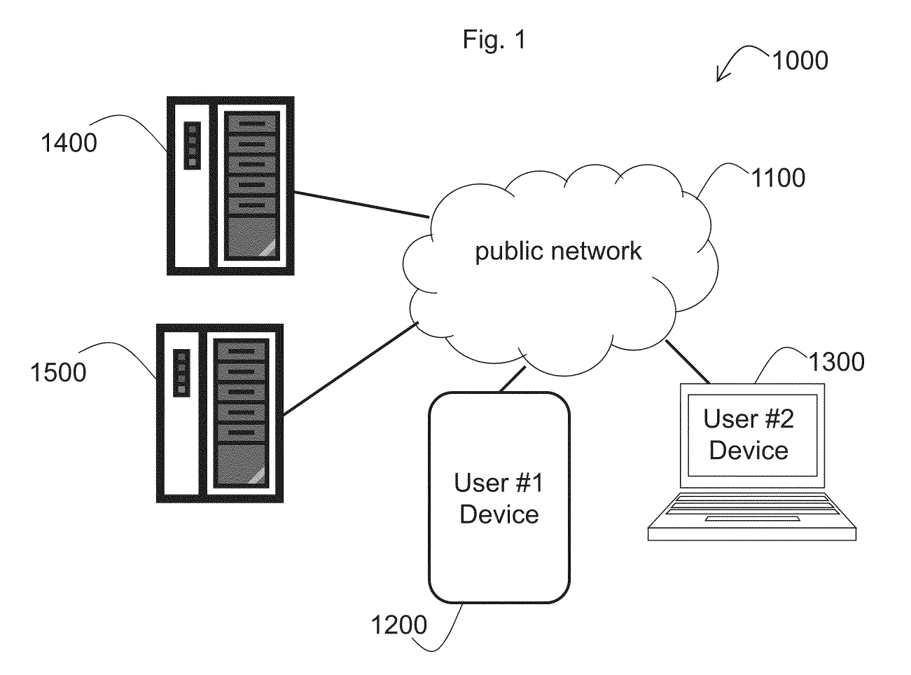

FIG. 1 shows a system 1000 for graphical display of geographic data for employment opportunities according to an embodiment of the present invention. The system 1000 generally includes an employment search server system 1400, which may be distributed on one or more physical servers, each having processor, memory, an operating system, and input/output interface, and a network interface all known in the art, one or more maps servers 1500, and a plurality of end user computing devices 1200/1300 coupled to a public network 1100, such as the

Internet and/or a cellular or wireless network. The employment search server system 1400 may be a cloud computing based system. The user computing devices 1200/1300 can be a desktop, laptop, tablet, smart phone or other portable or mobile device, or similar electronic device.

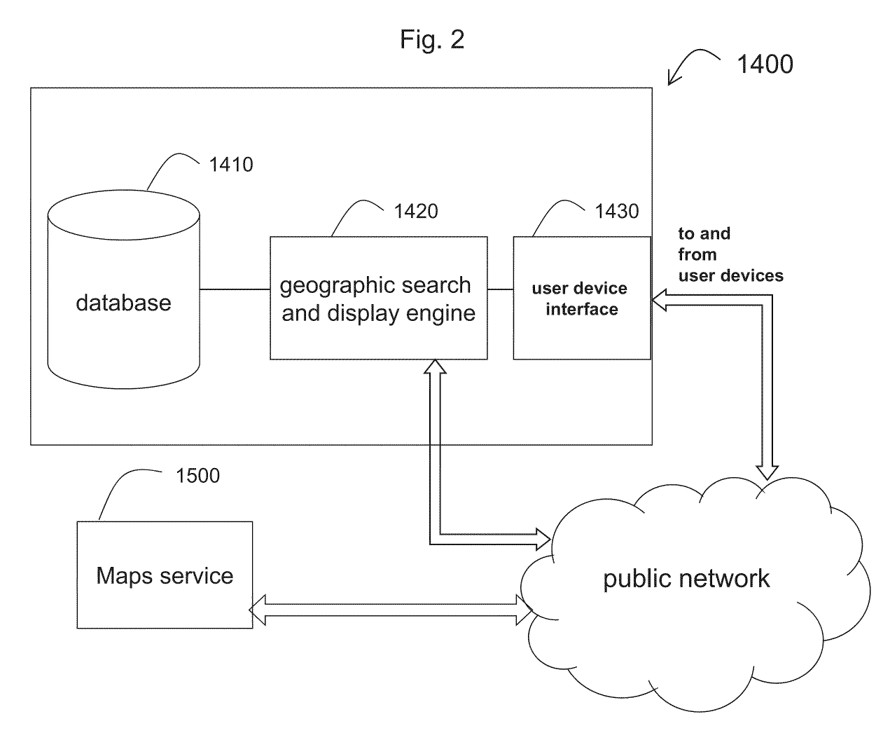

Turning to the employment search server system 1400, an exemplary embodiment is shown in FIG. 2. Generally, an employment search server system 1400 includes a geographic search and display engine 1420 designed to provide employment opportunity search and graphical display of employment opportunities with geographic data in a map. The engine 1420 receives employment opportunity data and stores the data in a database 1410 from the user, employer or vendor. The employment opportunity data also can be entered by an administrator of the system 1400. The data may also be entered by a paying employer, vendor, user, and so on, or by a program. The data may include, for example, one or more addresses (e.g., of the employer, vendor, user, and so on) and any other information relating to the employment opportunity, the employer, vendor, or user. The engine 1420 then uses the data, e.g., an address, to find the geographic data, e.g., latitude and longitude, of the location of the employer, vendor, user, and so on. The engine 1420 finds the geographic data using an online map service 1500, such as Google Maps, Apple Maps, MapQuest, and the like. The online map service 1500 provides application program interfaces (APIs) that the engine 1420 can use to find and retrieve the geographic data. For example, Google Maps provides APIs at https://developers.google.com/maps/, MapQuest provides APIs at http://developer.mapquest.com/web/products/featured/apple-ios-maps-api, and so on. The engine 1420 saves the geographic data in the database 1410 along with the other employment opportunity data above.

Alternatively, a user communicates through a user device 1200/1300 with GPS capability, the engine 1420 may retrieve the geographic data, e.g., latitude and longitude, from the user device 1200/1300. The engine 1420 may then use the geographic data and the map service 1500 to find the zip code for the employer, vendor, or user.

The employers, vendors, or users may need to register with the system 1400 before using the system 1400. Alternatively, a tier of employers, vendors, or users may use the system 1400 without registration. The registration may be free of charge, or the employers, vendors, or users may have to pay a subscription fee. As such, the data stored in the database 1410 may also include address of the employers, vendors, or users, payment information, user device information, and so on. For a user who registers and gives an address, the engine 1420 also finds and stores the geographic data of the user's address in the database 1410. Other data saved in the database 1410 may include metrics and analytics data from the online sessions performed by the user.

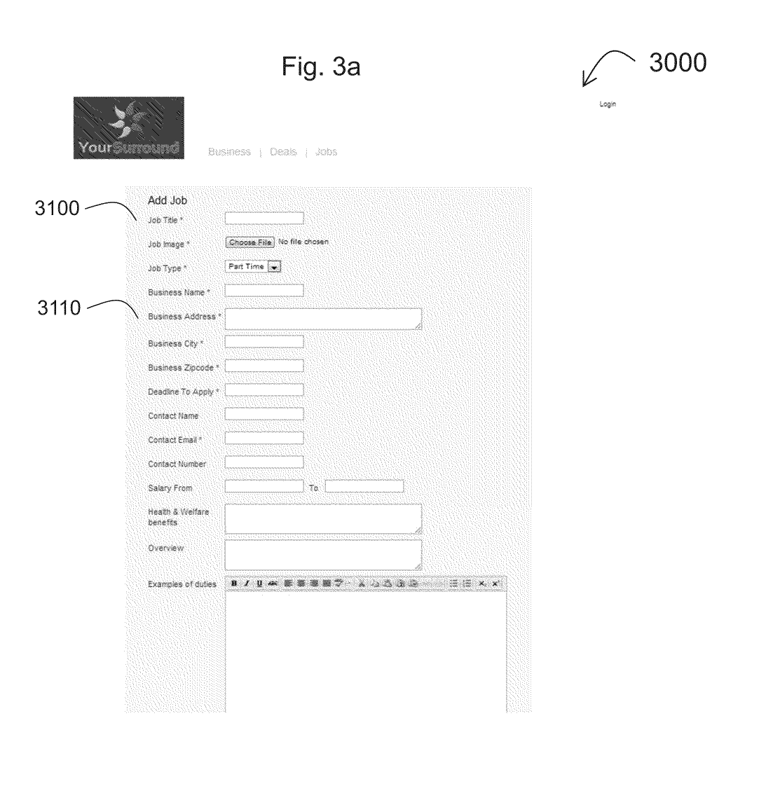

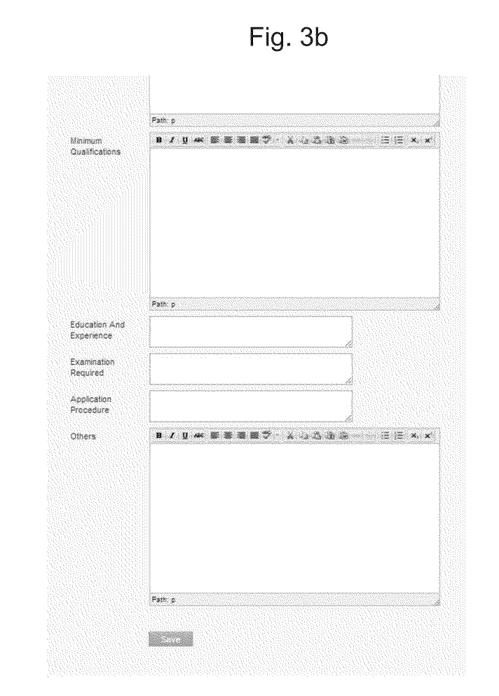

FIGS. 3a-3b show an exemplary user interface 3000 for an administrator, an employer, a vendor, and so on, to enter data for an employment opportunity. The administrator, employer, or vendor enters at least the job title 3100 and address information 3110 (e.g., street address, city, zip code, and so on). As described above, the engine 1420 then uses the address information to find the geographic data, e.g., latitude and longitude, using a map service 1500. The engine 1420 saves the geographic data in the database 1410 along with the other employment opportunity data that is entered via user interface 3000.

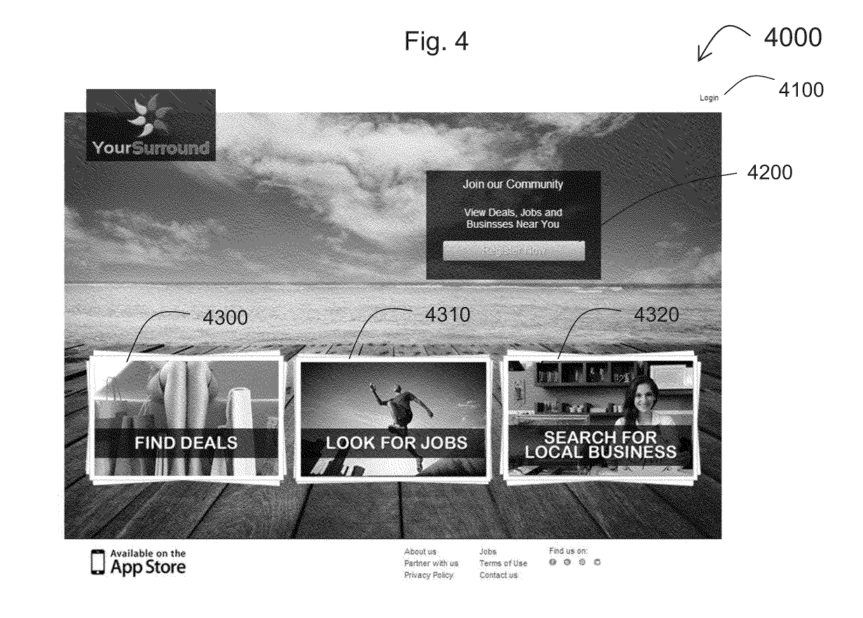

FIG. 4 shows an exemplary user interface 4000 of the landing page of the employment search server system 1400. The user interface 4000 provides a login interface 4100 for employers, vendors, or users who have registered with the system 1400. Employers, vendors, or users who have not registered with the system 1400 may register using the registration interface 4200. The user interface 4000 also includes one or more application interfaces 4300, 4310, 4320. An interface 4000 could be directed to sales of goods or services. For example, a “Find Deals” application would include information about discounted items being promoted by the application. A user looking for deals can select the Find Deals application interface 4300. A user looking for employment opportunities will select the Look for Jobs application interface 4310. A user looking for local businesses (e.g., stores, restaurants, and so on) will select the Search for Local Business application interface 4320. More application interfaces will be added as more applications are added to the system 1400.

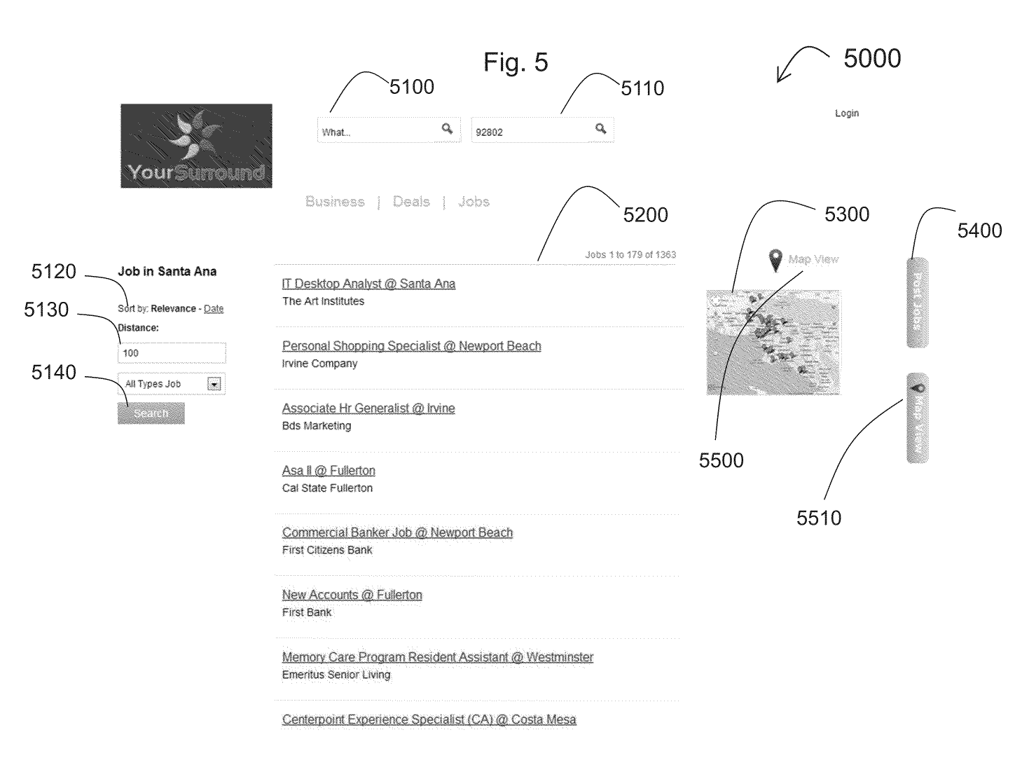

FIG. 5 shows an exemplary user interface 5000 of the employment search server system 1400. The user interface 5000 shows an exemplary employment opportunity search interface. To perform a search, a user enters a job type, e.g., Accountant, IT Analyst, and so on, in window 5100. In window 5110, the user enters a location, e.g., zip code, city, and so on, where the user wants the system 1400 to search for the desired job type. In window 5130, the user enters or selects the distance (e.g., in miles) from the location entered in 5110 to request the system 1400 to include all employment opportunities within that distance. The user may select the sorting preference 5120 when the system 1400 displays the employment opportunity listing. When the user clicks the Search button 5140, the engine 1420 will search (for example, using MySQL) for employment opportunities in the database 1410 having at least the job title entered in 5100 in or within the distance 5130 of the location entered in 5110. The engine 1420 may use exact matching or any of various types of matching (e.g., closely matched words, closely related words, etc.) for the search. If no job title or other search criteria is selected, all opportunities will be displayed. If only a geographic location is the only search criteria selected, opportunities within a certain distance from the location, e.g., 100 miles, will be displayed. If a registered user logged in before performing the search, the system may automatically display the search city/zipcode/county according to the user's registered information. Alternatively, the system may automatically display the search location criteria entered during the user's previous search.

When the engine 1420 finds an employment opportunity, it retrieves the geographic data, e.g., latitude and longitude, of that employment opportunity from the database 1410. The engine 1420 uses the geographic data and the APIs of a map service 1500 to display an indication (e.g., a pin, or a pin with a letter or number corresponding to the employment opportunity, and the like) for the employment opportunity on a map 5300. The engine 1420 displays indications for one or more employment opportunities found.

If the user registered with the system 1400 and gave the user's address (FIGS. 3a-3b), the engine 1420 also displays the user's location on the map 5300. Alternatively, if the user uses a user device 1200/1300 with GPS, the engine 1420 may retrieve the geographic data, e.g., latitude and longitude, from the user device 1200/1300, uses the map service's APIs to display the user's location on the map 5300.

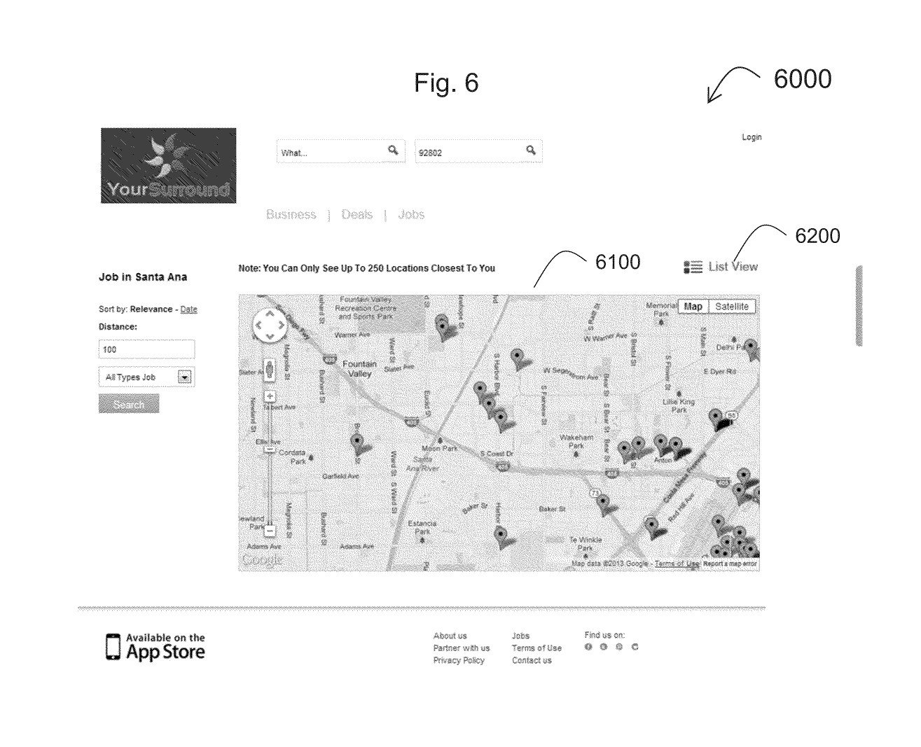

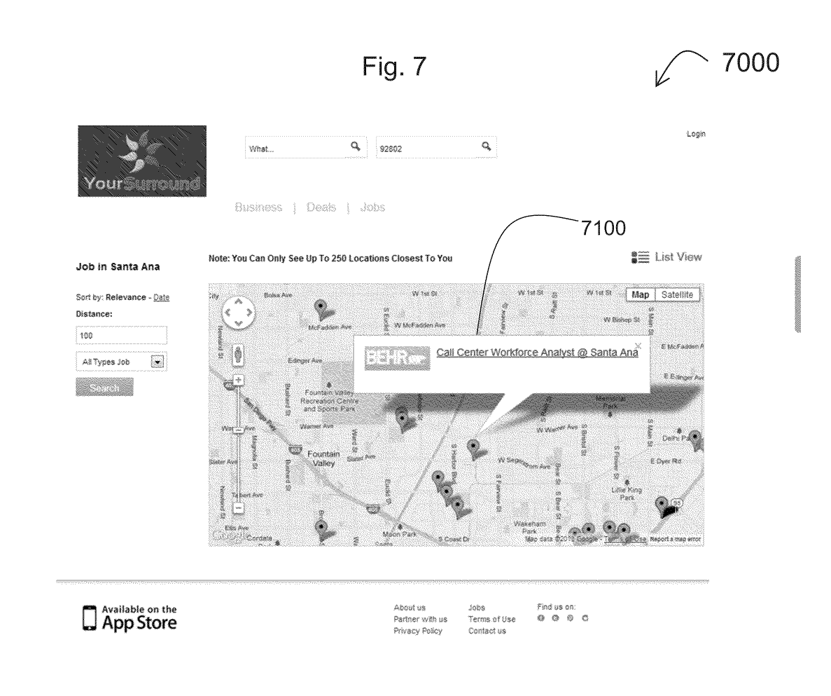

The user may select Map View button 5500 or Map View tab 5510 to display a large map view (FIGS. 6 and 7). The user (e.g., an administrator, employer, or vendor) may also select Post Jobs tab 5400 to enter an employment opportunity.

The engine 1420 also displays a listing 5200 of the employment opportunities in the sorting preference indicated by the user in window 5120.

FIG. 6 shows an exemplary user interface 6000 of the employment search server system 1400. When the user selects the Map View button 5500 or Map View tab 5510 as shown in FIG. 5, the engine 1420 displays the large map view of user interface 6000. To return to the list view as shown in FIG. 5, the user selects the List View 6200. When the user clicks on or hover a user input interface, e.g., a mouse cursor, over a location (shown with a pin) on the map 6100, the engine 1420 provides a pop-up window 7100, as shown in FIG. 7, displaying further information of the employment opportunity. Users may also adjust the map view by using the zooming function of the computer or device or by shifting the view of the map to the East, North, South or

West by using the mouse. This would change the view but not the search criteria. Alternatively, zooming or shifting the map view will change the geographic search criteria to find and display the location of job opportunities in the newly displayed search radius or area.

### Preferred Processes

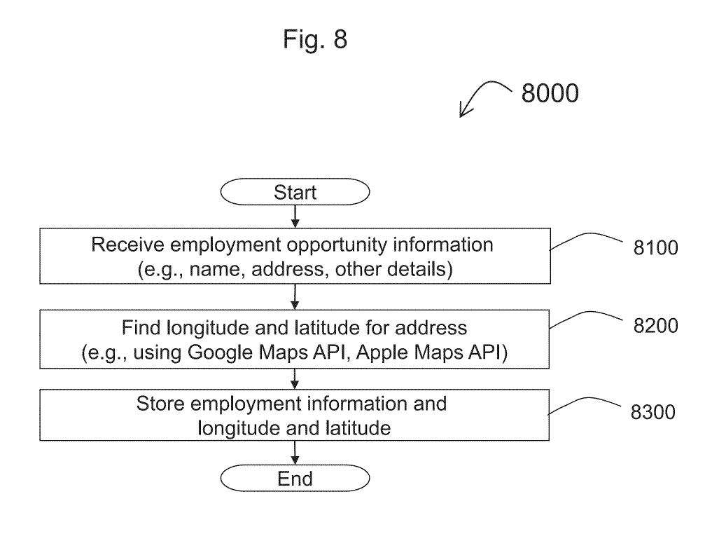

FIG. 8 shows an exemplary description of the operation 8000 of the employment search server system 1400. After an employer, vendor, or user registers with the system 1400, including paying, if required, the employer, vendor, or user logs into the system 1400 to enter the employment opportunity data, e.g., name, address, and so on (Action Block 8100). The engine 1420 then uses the address to find the geographic data, e.g., latitude and longitude, of the location of the employer, vendor, or user from a map server 1500, such as Google Maps, Apple Maps, MapQuest, and the like (Action Block 8200). The engine 1420 then stores the geographic data in the database 1410 (Action Block 8300). As mentioned above, the engine 1420 may also retrieves the geographic data from the user device 1200/1300 of the employer, vendor, or user, when the user device 1200/1300 has GPS capability.

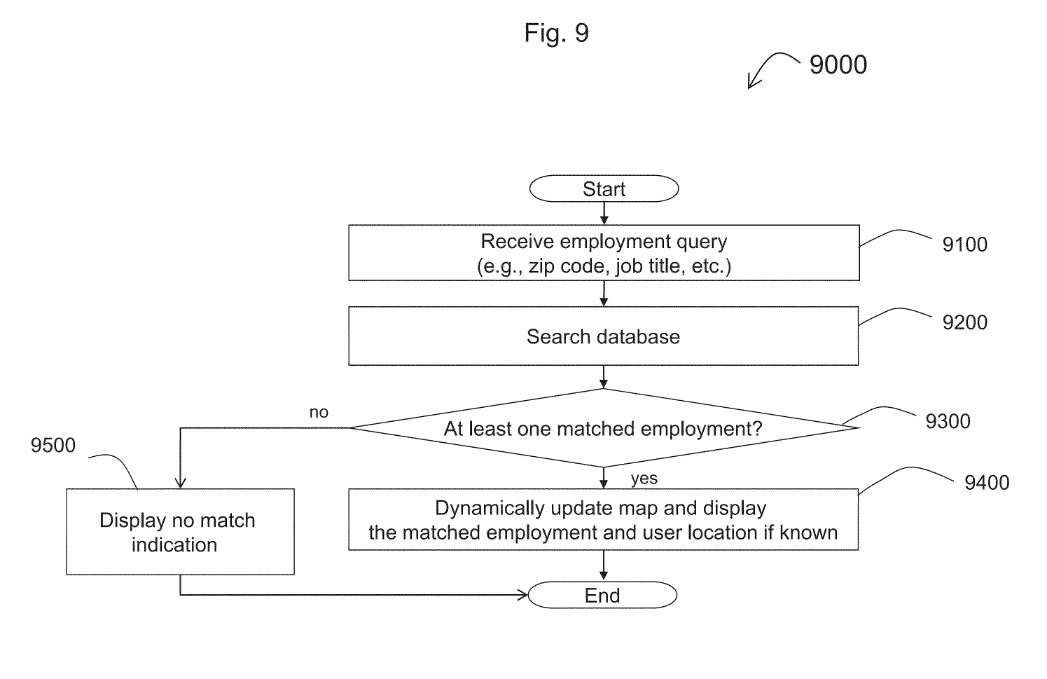

FIG. 9 shows an exemplary description of the operation 9000 of the employment search server system 1400. After a user logs into the system 1400, the user enters, and the engine 1420 receives one or more queries for employment opportunities (Action Block 9100). The query includes, for example, job title, zip code, distance, and so on. Based on the information in the query, the engine 1420 searches the database 1410 for one or more employment opportunities with at least a data matching the query information (Action Block 9200). If the engine 1420 finds one or more employment opportunities (Decision Block 9300), it retrieves the geographic data, e.g., latitude and longitude, of those employment opportunities from the database 1410. The engine 1420 then uses the geographic data and the APIs of a map service 1500 to display an indication (e.g., a pin, or a pin with a letter or number corresponding to the employment opportunity, and the like) for each of the employment opportunities on a map 5300 (Action Block 9400). If there is no matching employment opportunity found in the database 1410 (Decision Block 1410), the engine 1420 displays a no match indication (Action Block 9500).

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions described herein is merely illustrative, and the invention may appropriately be performed using different or additional process actions, or a different combination or ordering of process actions. For example, this invention is particularly suited for enabling the graphical display of geographic data for employment opportunities; however, the invention can be used for any graphical display of geographic data in general, for example, deals opportunities, local businesses, and so on. Additionally and obviously, features may be added or subtracted as desired. Accordingly, the invention is not to be restricted except in light of the attached claims and their equivalents.

What is claimed is:

1. A method of graphically displaying the locations of a plurality of employment opportunities identified by an employment search server system operatively connected to a public network, the search server system having a database including data associated with employment opportunities and location information, the search server system capable of identifying opportunities corresponding to certain search criteria, the method comprising:
storing employment opportunities in the database in association with said certain search criteria and location information;
receiving an employment opportunity query including one or more search criteria;
searching the database for employment opportunities matching the search criteria;
identifying employment opportunities matching the search criteria;
finding within the database the location information associated with the identified employment opportunities; and,
displaying the location information associated with the identified employment opportunities on a geographic representation.

2. The method of graphically displaying the locations of a plurality of employment opportunities of claim 1 wherein the plurality of employment opportunities is two or more.

3. The method of graphically displaying the locations of a plurality of employment opportunities of claim 2 wherein the search criteria includes a target location of an employment opportunity.

4. The method of graphically displaying the locations of a plurality of employment opportunities of claim 3 wherein the target location is an identified distance from a specific location.

5. The method of graphically displaying the locations of a plurality of employment opportunities of claim 4 wherein the specific location is determined by GPS information from a mobile device.

6. The method of graphically displaying the locations of a plurality of employment opportunities of claim 4 wherein the specific location is an address specified by the user.

7. The method of graphically displaying the locations of a plurality of employment opportunities of claim 4 wherein the specific location is selected from the group consisting of a state, county, city, town, municipality, village or intersection.

8. The method of graphically displaying the locations of a plurality of employment opportunities of claim 1, wherein the step of displaying the location information utilizes a map service.

9. The method of graphically displaying the locations of a plurality of employment opportunities of claim 3 wherein the search criteria includes a minimum salary.

10. A computer-based employment search server system for displaying on a representation of a map the locations of two or more employment opportunities matching certain search criteria, the server system comprising:
a database containing employment opportunity data including criteria associated with employment opportunities and locations of the employment opportunities;
a connection to a public network;
a processor capable of searching for and identifying a plurality of employment opportunities based on matching one or more of the employment opportunity criteria and a target location;
wherein the processor is capable of identifying locations of the identified employment opportunities and displaying the locations on a computer-based representation of a map.

11. The computer-based employment search system of claim 10, wherein the processor communicates with a map service.

12. The computer-based employment search system of claim 10, wherein the target location is selected from the group consisting of a county, city, municipality, village, intersection or street address.

13. The computer-based employment search system of claim 10, wherein the target location is the location of a user communicating with the employment search server through the public network.

14. The computer-based employment search system of claim 10, wherein the target location is determined from the GPS coordinates supplied by a mobile device.

15. A computer-based system of claim 14, wherein the processor is further capable of displaying the location of the mobile device on the representation of a map in addition to the locations of the identified employment opportunities.
